(19) United States
(12) Patent Application Publication
(10) Pub. No.: US 2004/0057238 A1
(43) Pub. Date: Mar. 25, 2004

(54) Light Source System With Open Flames

(75) Inventor: Dirk Karl-Heinz Ackermann, Munich (DE)

Correspondence Address: DIRK ACKERMANN, ELISABETHSTRASSE 2, MUNICH, 80796, DE

(73) Assignee: Dirk Ackermann, Munich (DE)

(21) Appl. No.: 10/604,053

(22) Filed: Jun. 24, 2003

(30) Foreign Application Priority Data
Jun. 26, 2002 (DE) DE 202 10 263 U 1

(51) Int. Cl. F21V 35/00

(52) U.S. Cl. 362/392; 362/810

(57) ABSTRACT

The light source system is a combination of two light sources with open flames that are placed in a multiple-legged, tube-like u-shaped container. The arrangement of the light sources is that one light source burns in the bottom of one leg with an upward-directed flame, and the other light source burns with a visibly downward-directed flame in the upper part of the second leg.

### DETAILED DESCRIPTION

An open flame always creates a comfortable atmosphere by emitting light in the spectral range of warm colors. Because the resulting ambience is unique, you can still find such simple and archaic light sources widely spread in all domains of human life today, especially in the domestic and gastronomy sectors. Referenced in historical documents and available on today's market, you can find innumerable varieties of such light sources, however, they all have upward-burning flames.

The purpose of this patent application is to propose a new light source system which changes the flame direction from upwards to horizontal or even downwards through simple means.

The system combines at least one downward-directed open flame and at least one heat source, which can also be a light source. Each is placed in a leg of an u-shaped tube-like container where the two open ends are pointed up. In the bottom of one of these legs, an upward-directed heat source is placed, which generates an air stream through both legs. In the other leg, a downward-directed flame (light source) burns, which is pulled downwards more strongly by the air stream.

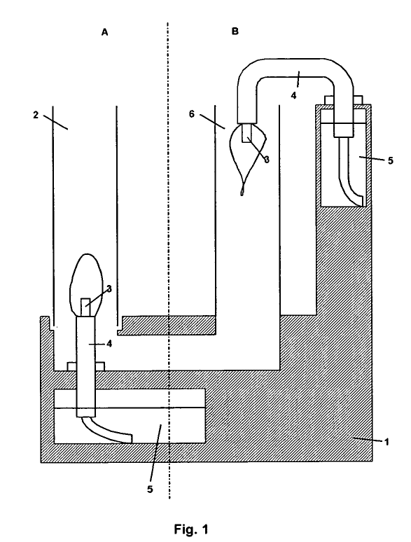

The invention is described in more detail in FIG. 1. FIG. 1 shows a possible arrangement of the components of the light source system described previously. The number (1) represents the outer body of the system, which is made of a non-flammable material such as glass. Area A stands for the oil-filled reservoir and the lit wick of the oil lamp. The removable glass cylinder (2) serves as a funnel for the upwards-oil lamp (Area A). This glass cylinder (2), the body (1) and the second glass cylinder (6) together form a u-shaped container. Inside the container is a heat source and a light source in this case both oil lamps consisting of wicks (3), removable wick tubes (4) and oil reservoirs (5). If the first oil lamp is lit (Area A), an upward air stream is generated in the first cylinder (2). Since the second cylinder (6) is connected to the first cylinder (2) via the body (1), a downward air stream is generated in the second cylinder (6). If the second oil lamp in the second cylinder (6) is now lit, the flame burns downwards, provided the wicks are adjusted correctly.

1. Light source system with open flames, consisting of:
A body (1), on which is at least one cylinder (2) and at least a second transparent cylinder (6) whose top ends are open and whose ends are connected by the body (1) to form a u-shaped container enabling an unrestricted air stream between the two upper leg (2,6) openings through the body (1).
Heat sources or fans which generate an upward-directed air stream in one leg (2), which results in an downward-directed air stream in the other leg (6) through the u-shaped container.
A light source with a visibly downward burning flame, whose burning direction is generated by the downward-directed air stream.
